(19) United States
(12) Patent Application Publication
(10) Pub. No.: US 2026/0009569 A1
(43) Pub. Date: Jan. 8, 2026

(54) REFRIGERANT MANIFOLD

(71) Applicant: Hanon Systems, Daejeon (KR)

(72) Inventor: Byung Joo KIM, Daejeon (KR)

(73) Assignee: Hanon Systems, Daejeon (KR)

(21) Appl. No.: 19/219,979

(22) Filed: May 27, 2025

(30) Foreign Application Priority Data
Jul. 5, 2024 (KR) 10-2024-0088599

(51) Int. Cl. F25B 41/40; B60H 1/00; B60H 1/32

(52) U.S. Cl. CPC F25B 41/40; B60H 1/00528; B60H 1/3229

(57) ABSTRACT

The present invention relates to a refrigerant manifold including a housing, a plurality of component mounting parts disposed on one surface of the housing and having component insertion holes formed in the same direction, the component insertion holes being configured such that components are inserted into component insertion holes, and a connection flow path configured to connect the component insertion holes of the plurality of component mounting parts, in which the component insertion holes connected by the connection flow path are disposed with a height difference H1, thereby reducing a size of a package.

### CROSS REFERENCE TO RELATED APPLICATION

The present application claims priority to Korean Patent Application No. 10-2024-0088599, filed on Jul. 5, 2024, the entire contents of which are incorporated herein for all purposes by this reference.

### BACKGROUND OF THE INVENTION

### Field of the Invention

The present invention relates to a refrigerant manifold applied to a cooling module constituting a cooling system for a vehicle, and more particularly, to a refrigerant manifold configured to connect a refrigerant pipe and components such as a heat exchanger and a valve.

### Description of the Related Art

Recently, as there is gradually increasing interest in energy efficiency and problems of environmental pollution, there is a need for development of environmental-friendly vehicles that can substantially replace internal combustion engine vehicles. The environmental-friendly vehicles are typically classified into an electric vehicle which operates by using fuel cells or electricity as a power source, and a hybrid vehicle that operates by using an engine and a battery.

Unlike an air conditioning device for a general vehicle, a separate heater is not used for an electric vehicle or a hybrid vehicle among the environmental-friendly vehicles. The air conditioning system applied to the environmental-friendly vehicle typically refers to a heat pump system.

Meanwhile, the electric vehicle generates driving power by converting energy, which is generated by a chemical reaction between oxygen and hydrogen, into electrical energy. In this process, because thermal energy is generated by a chemical reaction in a fuel cell, it is essential to effectively remove generated heat to ensure performance of the fuel cell.

Further, the hybrid vehicle also generates driving power by operating an engine that uses general fuel to operate and operating a motor by using electric power supplied from the fuel cell or an electric battery. Therefore, to ensure performance of the motor, it is necessary to effectively remove heat generated from the fuel cell or battery and the motor.

Therefore, in a hybrid vehicle or an electric vehicle in the related art, a cooling system, a heat pump system, and a battery cooling system are provided. Therefore, a refrigerant manifold is used to reduce a size and weight of a cooling module and simplify layouts of pipes that connect a plurality of heat exchangers and a plurality of valves.

For example, the refrigerant manifold may have a two-layer structure in which a first housing, a middle plate, and a second housing are stacked and then joined by brazing. The refrigerant manifold having the two-layer structure may freely form a shape of a refrigerant flow path, thereby reducing a size of a package. However, because the refrigerant manifold of the two-layer structure has the structure in which the first housing, the middle plate, and the second housing are stacked and joined by brazing, a sealing defect may occur in the joined portion, and the refrigerant may leak, which may degrade durability.

In another example, in order to reduce a likelihood of a leak of the refrigerant in the refrigerant manifold and improve the durability, the refrigerant manifold may have a one-layer structure formed by forging a block-shaped material and then machining components, parts on which a flange of the refrigerant pipe is to be mounted, and refrigerant flow paths, such that the one-layer structure has one body without a joined portion. However, the refrigerant manifold having the one-layer structure has a problem in that a size of a package increases because of structural and processing characteristics of the refrigerant flow path. Further, in case that the refrigerant manifold is manufactured by forging, the forging processing may be performed by using upper and lower mold, and a slide core cannot be used. In case that directions of component mounting parts, which are parts into which components, such as valves, are inserted and mounted, are different from movement directions of the upper and lower molds, the component mounting parts are inevitably manufactured to have shapes having completely filled interiors, which causes a problem in that weights of materials are increased, and machining processing time for forming holes in the component mounting parts are increased.

### DOCUMENT OF RELATED ART

[Patent Document] KR 10-2022-0162479 A (Dec. 8, 2022) “Integrated Cooling Module”

### SUMMARY OF THE INVENTION

The present invention is proposed to solve these problems and aims to provide a refrigerant manifold that is a refrigerant manifold having one-layer structure manufactured by forging processing, such that a size of a package may be reduced, and the refrigerant manifold is easily manufactured.

In order to achieve the above-mentioned object, the present invention provides a refrigerant manifold including: a housing; a plurality of component mounting parts disposed on one surface of the housing and having component insertion holes formed in the same direction, the component insertion holes being configured such that components are inserted into component insertion holes; and a connection flow path configured to connect the component insertion holes of the plurality of component mounting parts, in which the component insertion holes connected by the connection flow path are disposed with a height difference.

In addition, one end of the connection flow path may be formed in a lateral surface of one component insertion hole, and the other end of the connection flow path may be formed in a bottom surface of another component insertion hole.

In addition, another component insertion hole may be disposed to be higher than one component insertion hole.

In addition, a depth of one component insertion hole and a depth of another component insertion hole may be equal to each other.

In addition, an upper end of another component insertion hole may be disposed to be higher than an upper end of one component insertion hole.

In addition, a lower end of another component insertion hole may be disposed to be higher than a lower end of one component insertion hole and lower than an upper end of one component insertion hole.

In addition, the connection flow path may include a lateral flow path extending from the lateral surface of one component insertion hole to a height lower than a lower end of another component insertion hole.

In addition, the connection flow path may include: a vertical flow path extending downward from the bottom surface of another component insertion hole; and a horizontal flow path extending from a lateral surface of the housing and configured to connect the lateral flow path and the vertical flow path.

In addition, all the lateral flow path, the vertical flow path, and the horizontal flow path may be formed in straight shapes.

In addition, the lateral flow path may be formed to have an inclination angle, which is an acute angle, with respect to a central axis of one component insertion hole.

In addition, an upper end of the horizontal flow path may be disposed to be higher than a lower end of one component insertion hole.

In addition, a height from a central axis of the horizontal flow path to a lower end of the housing at a portion where the horizontal flow path may be formed to correspond to a height difference between the component insertion holes connected by the connection flow path.

In addition, one end of the horizontal flow path may be connected to the lateral flow path, the other end of the horizontal flow path may be formed in the lateral surface of the housing, and the vertical flow path may be connected between two opposite ends of the horizontal flow path.

In addition, the other end of the horizontal flow path may be a port connected to a heat exchanger.

In addition, the plurality of component mounting parts may be valve mounting parts on which valves are mounted.

In addition, the plurality of component mounting parts may further include component fastening holes disposed adjacent to the component insertion holes, and fastening members are fastened to the component fastening holes.

In addition, the housing may be configured as one body without a joined portion.

In addition, the housing may be formed by performing forging processing on a material having one block shape.

In addition, the connection flow path may be formed through the inside of the housing by machining processing.

In addition, an upper end of the component mounting part is formed to have a flat surface configured to come into contact with the component.

### BRIEF DESCRIPTION OF THE DRAWINGS

FIG. 1 is an assembled perspective view illustrating a state in which components (valves) are mounted on a refrigerant manifold according to an embodiment of the present invention.

FIG. 2 is an exploded perspective view illustrating a state in which the components (valves) are disassembled from the refrigerant manifold according to the embodiment of the present invention.

FIG. 3 is a front cross-sectional view of FIG. 1.

FIG. 4 is a front cross-sectional view illustrating the refrigerant manifold according to the embodiment of the present invention.

FIG. 5 is a front cross-sectional view illustrating a height difference between component insertion holes, an inclination angle of a lateral flow path, and a height of a lower end of a housing of a portion for forming a horizontal flow path in the refrigerant manifold according to the embodiment of the present invention.

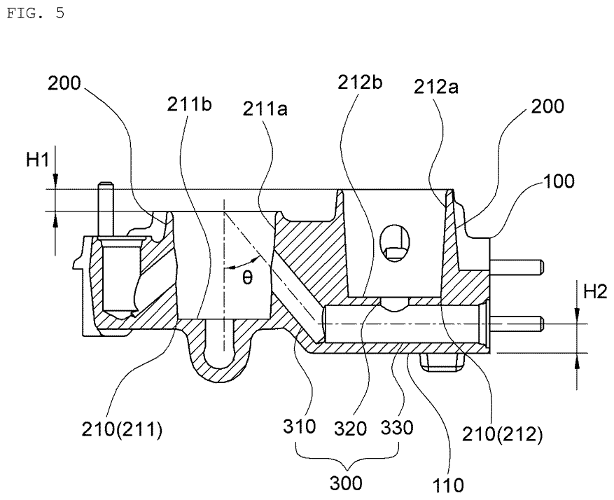

### DETAILED DESCRIPTION OF THE INVENTION

Hereinafter, a refrigerant manifold of the present invention configured as described above will be described in detail with reference to the accompanying drawings.

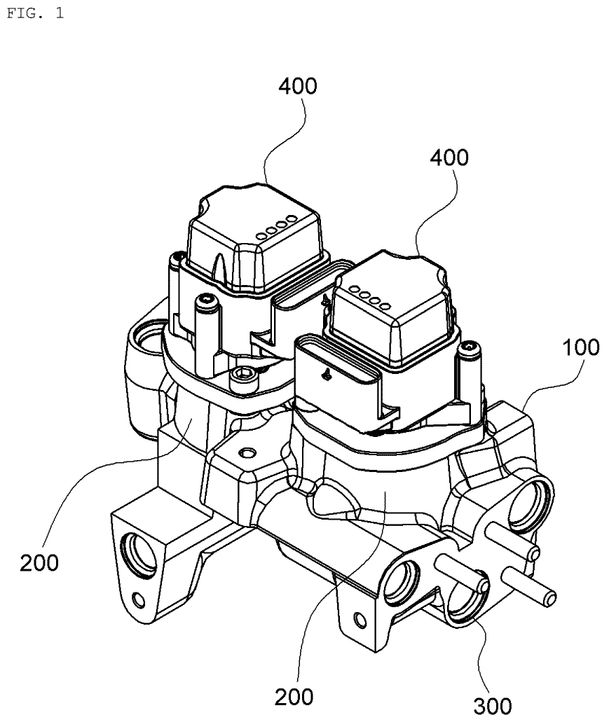

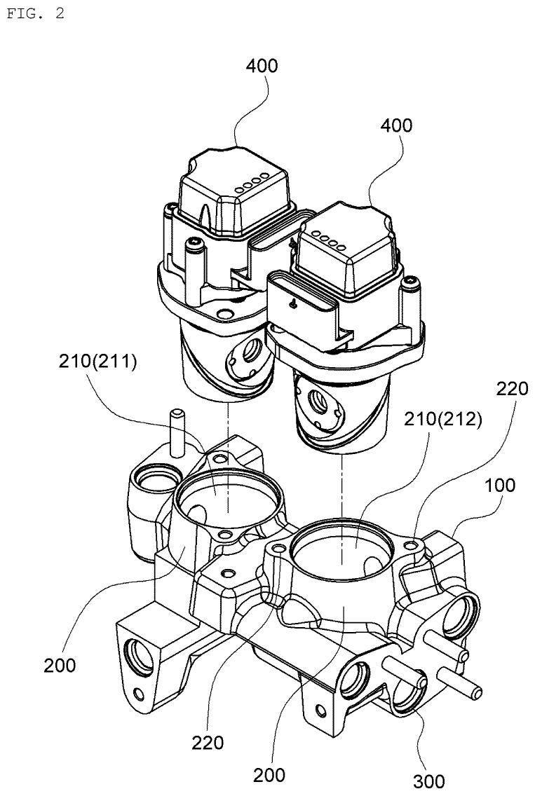

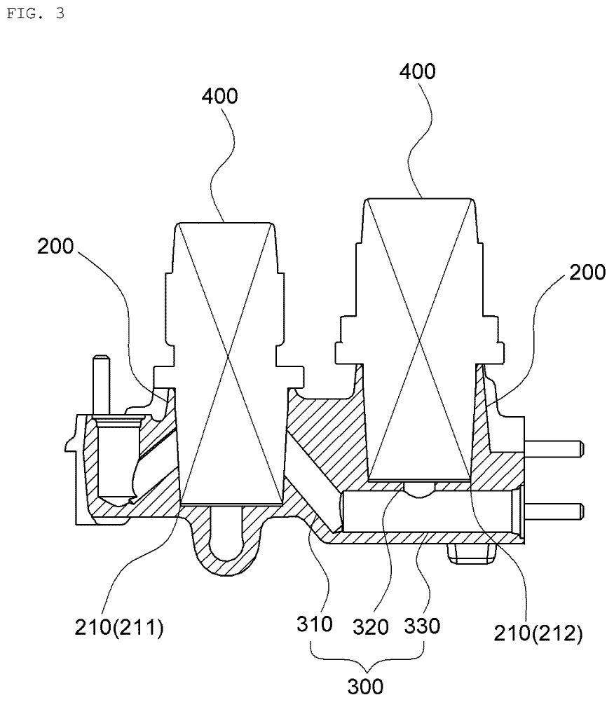

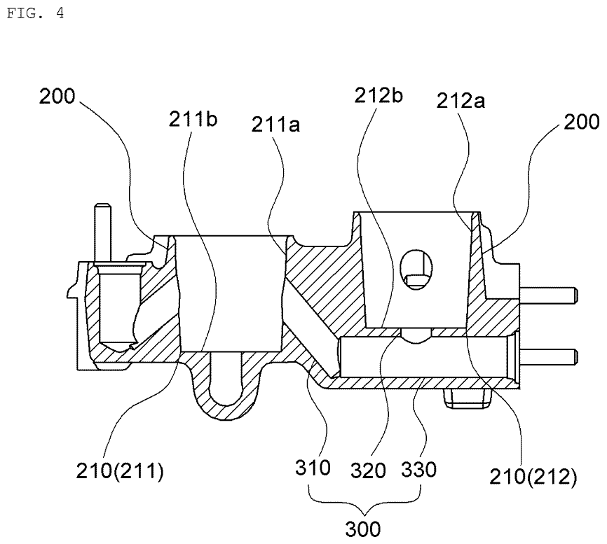

FIG. 1 is an assembled perspective view illustrating a state in which components (valves) are mounted on a refrigerant manifold according to an embodiment of the present invention, FIG. 2 is an exploded perspective view illustrating a state in which the components (valves) are disassembled from the refrigerant manifold according to the embodiment of the present invention, FIG. 3 is a front cross-sectional view of FIG. 1, and FIG. 4 is a front cross-sectional view illustrating the refrigerant manifold according to the embodiment of the present invention.

As illustrated, the refrigerant manifold according to the embodiment of the present invention may include a housing 100, a plurality of component mounting parts 200, and a connection flow path 300.

The housing 100 may be formed by performing forging processing on a metallic material having one block shape and have one-layer structure configured as one body without a joined portion.

The plurality of component mounting parts 200 are parts on which the components are mounted. The plurality of component mounting parts 200 may be formed on an upper surface of the housing 100. In this case, the components may be target components mounted on the component mounting parts 200. For example, the components may be valves 400. The valve may be an expansion valve or a general direction switching valve. In addition, the components may be various components such as a heat exchanger or a sensor. The plurality of component mounting parts 200 may include component insertion holes 210 concavely formed in the housing 100. The plurality of component mounting parts 200 may further include component fastening holes 220 formed adjacent to the component insertion holes 210. An upper end of the component mounting part 200 may have a flat surface that may come into contact with the component. The component insertion hole 210 may be provided in the form of a hole concavely formed from above to below. A lower side of the valve 400, which is the component, may be inserted and coupled into the component insertion hole 210. The component fastening hole 220 may be provided in the form of a hole concavely formed from above to below. A fastening member may be fastened to the component fastening hole 220. Therefore, the valve 400 may be easily coupled and fixed to the component mounting part 200 by using a fastening member such as a bolt. In addition, the plurality of component mounting parts 200 may be disposed to be spaced apart from one another in a horizontal direction. Approximately shapes of the component insertion holes may be easily formed when the housing is manufactured by the forging processing.

The connection flow path 300 is connected to the component insertion holes 210 of the plurality of component mounting parts 200. For example, the two adjacent component mounting parts 200 may be connected by the connection flow path 300. A lateral surface 211a of a first component insertion hole 211, which is one component insertion hole, and a bottom surface 212b of a second component insertion hole 212, which is another component insertion hole, may be connected by the connection flow path 300. That is, one end of the connection flow path 300 may be formed in the lateral surface 211a of the first component insertion hole 211, and the other end of the connection flow path 300 may be formed in the bottom surface 212b of the second component insertion hole 212. In addition, the connection flow path 300 may be formed through the inside of the housing 100 by machining processing.

In this case, the first component insertion hole 211 and the second component insertion hole 212, which are connected by the connection flow path 300, may be disposed with a height difference H1, and the second component insertion hole 212 may be disposed to be higher in height than the first component insertion hole 211. For example, a depth of the first component insertion hole 211 and a depth of the second component insertion hole 212 are equal to each other. An upper end of the second component insertion hole 212 is disposed to be higher than an upper end of the first component insertion hole 211, and a lower end of the second component insertion hole 212 may be disposed to be higher than a lower end of the first component insertion hole 211. Further, the lower end of the second component insertion hole 212 may be disposed to be lower than the upper end of the first component insertion hole 211.

Therefore, because the refrigerant manifold of the present invention is configured such that the lower end of the second component insertion hole 212 is higher than the lower end of the first component insertion hole 211, a portion of the connection flow path 300, which is connected to the second component insertion hole 212, may be disposed adjacent to the bottom surface 212b of the second component insertion hole 212 when the connection flow path 300, which connects the lateral surface 211a of the first component insertion hole 211 and the bottom surface 212b of the second component insertion hole 212, is formed by machining processing. Therefore, a size of the housing 100 in the height direction may be reduced at a portion where the second component insertion hole 212 is present. That is, it is possible to reduce a size of a refrigerant manifold package in the height direction.

In addition, the connection flow path 300 may include a lateral flow path 310, a vertical flow path 320, and a horizontal flow path 330. All the lateral flow path 310, the vertical flow path 320, and the horizontal flow path 330 may be formed in straight shapes by machining processing. The lateral flow path 310 may extend from the lateral surface 211a of the first component insertion hole 211 to a height lower than the bottom surface 212b of the second component insertion hole 212. The lateral flow path 310 may be formed to have an inclination angle θ, which is an acute angle, with respect to a central axis of the first component insertion hole 211. The vertical flow path 320 may extend downward from the bottom surface 212b of the second component insertion hole 212. The horizontal flow path 330 may extend from the lateral surface of the housing 100, and the horizontal flow path 330 may be connected to the lateral flow path 310 and the vertical flow path 320. For example, one end of the horizontal flow path 330 may be connected to the lateral flow path 310, the other end of the horizontal flow path 330 may be formed in the lateral surface of the housing 100, and the vertical flow path 320 may be connected between two opposite ends of the horizontal flow path 330. Therefore, the connection flow path 300, which connects the lateral surface 211a of the first component insertion hole 211 and the bottom surface 212b of the second component insertion hole 212 may be easily formed. In this case, the other end of the horizontal flow path 330 may be a port connected to a heat exchanger such as an indoor unit.

In addition, an upper end of the horizontal flow path 330 may be disposed to be higher than a bottom surface 211b of the first component insertion hole 211. Further, a height H2 from a central axis of the horizontal flow path 330 to a lower end 110 of the housing 100 at the portion where the horizontal flow path 330 is formed may be equal or similar to a height difference H1 between the first component insertion hole 211 and the second component insertion hole 212. Therefore, it may be easy to ensure a space in which a chassis of a vehicle or other components may be disposed below the lower end 110 of the housing 100.

In addition, one end of the horizontal flow path 330 may be disposed outward of a lateral surface 212a of the second component insertion hole 212 in a radial direction of the second component insertion hole 212. Therefore, the lateral flow path 310 may be easily formed without interfering with the second component insertion hole 212.

In addition, the refrigerant manifold of the present invention may further include a refrigerant channel, and the refrigerant channel may be connected to the component insertion hole 210. Further, the refrigerant manifold of the present invention may have a flange mounting part on which a flange formed at an end of a refrigerant pipe is mounted.

According to the refrigerant manifold of the present invention, there is a height difference between the component insertion holes in which the components are mounted, such that the connection flow path configured to connect the component insertion holes is easily configured, thereby reducing the size of the package. The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Housing
110: Lower end
200: Component mounting part
210: Component insertion hole
211: First component insertion hole
212: Second component insertion hole
211a: Lateral surface
211b: Bottom surface
212a: Lateral surface
212b: Bottom surface
220: Component fastening hole
300: Connection flow path
310: Lateral flow path
320: Vertical flow path
330: Horizontal flow path
400: Valve
θ: Inclination angle of lateral flow path

What is claimed is:

1. A refrigerant manifold comprising:
a housing;
a plurality of component mounting parts disposed on one surface of the housing and having component insertion holes formed in the same direction, the component insertion holes being configured such that components are inserted into component insertion holes; and
a connection flow path configured to connect the component insertion holes of the plurality of component mounting parts,
wherein the component insertion holes connected by the connection flow path are disposed with a height difference.

2. The refrigerant manifold of claim 1, wherein one end of the connection flow path is formed in a lateral surface of one component insertion hole, and the other end of the connection flow path is formed in a bottom surface of another component insertion hole.

3. The refrigerant manifold of claim 2, wherein another component insertion hole is disposed to be higher than one component insertion hole.

4. The refrigerant manifold of claim 3, wherein a depth of one component insertion hole and a depth of another component insertion hole are equal to each other.

5. The refrigerant manifold of claim 3, wherein an upper end of another component insertion hole is disposed to be higher than an upper end of one component insertion hole.

6. The refrigerant manifold of claim 3, wherein a lower end of another component insertion hole is disposed to be higher than a lower end of one component insertion hole and lower than an upper end of one component insertion hole.

7. The refrigerant manifold of claim 2, wherein the connection flow path comprises a lateral flow path extending from the lateral surface of one component insertion hole to a height lower than a lower end of another component insertion hole.

8. The refrigerant manifold of claim 7, wherein the connection flow path comprises:
a vertical flow path extending downward from the bottom surface of another component insertion hole; and
a horizontal flow path extending from a lateral surface of the housing and configured to connect the lateral flow path and the vertical flow path.

9. The refrigerant manifold of claim 8, wherein all the lateral flow path, the vertical flow path, and the horizontal flow path are formed in straight shapes.

10. The refrigerant manifold of claim 7, wherein the lateral flow path is formed to have an inclination angle, which is an acute angle, with respect to a central axis of one component insertion hole.

11. The refrigerant manifold of claim 8, wherein an upper end of the horizontal flow path is disposed to be higher than a lower end of one component insertion hole.

12. The refrigerant manifold of claim 8, wherein a height from a central axis of the horizontal flow path to a lower end of the housing at a portion where the horizontal flow path is formed to correspond to a height difference between the component insertion holes connected by the connection flow path.

13. The refrigerant manifold of claim 8, wherein one end of the horizontal flow path is connected to the lateral flow path, the other end of the horizontal flow path is formed in the lateral surface of the housing, and the vertical flow path is connected between two opposite ends of the horizontal flow path.

14. The refrigerant manifold of claim 8, wherein the other end of the horizontal flow path is a port connected to a heat exchanger.

15. The refrigerant manifold of claim 1, wherein the plurality of component mounting parts are valve mounting parts on which valves are mounted.

16. The refrigerant manifold of claim 1, wherein the plurality of component mounting parts further comprise component fastening holes disposed adjacent to the component insertion holes, and fastening members are fastened to the component fastening holes.

17. The refrigerant manifold of claim 1, wherein the housing is configured as one body without a joined portion.

18. The refrigerant manifold of claim 1, wherein the housing is formed by performing forging processing on a material having one block shape.

19. The refrigerant manifold of claim 1, wherein the connection flow path is formed through the inside of the housing by machining processing.

20. The refrigerant manifold of claim 1, wherein an upper end of the component mounting part is formed to have a flat surface configured to come into contact with the component.
